(19) United States
(12) Patent Application Publication
(10) Pub. No.: US 2012/0216759 A1
(43) Pub. Date: Aug. 30, 2012

(54) HYDROXY BOOSTER SYSTEM

(76) Inventor: Wallace Taylor Irvin, Alvaton, KY (US)

(21) Appl. No.: 13/404,694

(22) Filed: Feb. 24, 2012

Related U.S. Application Data
(60) Provisional application No. 61/446,860, filed on Feb. 25, 2011.

(51) Int. Cl. F02B 43/10; C25B 15/00

(52) U.S. Cl. 123/3; 204/240

(57) ABSTRACT

An electrolysis system is provided for supplementing the petroleum fuel supply of an internal combustion engine. The electrolysis system may include a reservoir tank including a solution of water and electrolyte and at least two plates disposed therein. The plates are in electrical communication with a source of electrical power such that the plates create an electrical current in the solution to produce a gas including oxygen and hydrogen. A filter system is in fluid communication with the reservoir tank and includes a filter that has interconnected particles configured to capture electrolyte particles in the gas. A conduit is also provided as part of the electrolysis system to deliver the gas from the filter system to the internal combustion engine. A filter system and a method of supplying a gas that includes oxygen and hydrogen to supplement the petroleum fuel supply for an internal combustion engine are also disclosed.

### CROSS REFERENCE TO RELATED APPLICATIONS

This application claims the benefit of U.S. Provisional Patent Application No. 61/446,860 filed Feb. 25, 2011, which is incorporated in its entirety herein for all purposes.

### STATEMENT OF FEDERALLY SPONSORED RESEARCH OR DEVELOPMENT

Not applicable.

### BACKGROUND OF THE INVENTION

The invention relates to fuel supplementation systems for internal combustion engines. More specifically, the invention relates to an electrolysis system for producing a gas that includes oxygen and hydrogen to supplement the petroleum fuel supply for internal combustion engines to increase fuel efficiency and reduce harmful emissions.

Internal combustion engines are used in a wide variety of applications including, but not limited to, automobiles, busses, trucks, motorcycles, boats, aircraft, generators, and mobile equipment. These engines use a petroleum fuel supply, such as gasoline or diesel fuel. During the running cycle of such internal combustion engines, several substances are emitted as exhaust, such as carbon dioxide and water. However, these engines may also emit harmful toxins to the atmosphere due to incomplete combustion of fuel.

Specifically, incomplete combustion of fuel may lead to emissions of carbon monoxide, hydrocarbons, and nitrogen oxides. These gases may be poisonous and lead to the degradation of the environment by producing smog and acid rain. While only small traces of these gases may be emitted from any specific engine due to incomplete combustion of fuel, the overall amount of these harmful emissions and their effects on the environment are quite large and drastic when considering the world-wide use of internal combustion engines burning gasoline or diesel fuels.

Systems have been developed to attempt to reduce these problems. One such system that has been developed is an electrolysis system that uses an electrical current passed through a solution containing water to create a gas that includes hydrogen and oxygen gases to supplement an engine's primary fuel supply. The hydrogen and oxygen gases are formed by splitting water molecules into cations (Hydrogen) and anions (Hydroxide) by running an electrical current through the solution between two conductors forming a cathode and an anode. The hydrogen ions have a positive charge and are attracted to the cathode, where they accept an electron and combine with another hydrogen atom to form a hydrogen gas molecule, H₂. The hydroxide ions have a negative charge and thus are attracted to the anode. At the anode, the hydroxide ion releases an electron to the anode and by combining with three other hydroxide ions, forms one molecule of Oxygen gas, O₂, and two molecules of water, H₂O.

The hydrogen and oxygen gases that are formed may be collected for use in the internal combustion engine. The mixed gas of hydrogen and oxygen gases, which is often referred to by common names of Brown's Gas, oxyhydrogen, or hydroxide, may then be used to supplement the petroleum fuel supply for an internal combustion engine. By supplementing the petroleum fuel with both hydrogen and oxygen, a more complete combustion of the petroleum fuel is believed to occur, producing increased horsepower as well as reduced emissions of toxic substances as mentioned above.

While the electrolysis reaction used to create is not a new concept, the practical application of such a system has lacked widespread use due to a variety of problems. These problems include the electrolysis system introducing side effects that negatively affect components of the vehicles or equipment in which the internal combustion engines are used or negatively affect components of the internal combustion engine itself.

Additionally, the electrolysis systems of the prior art are often constructed in a rather crude manner and/or are of cumbersome design, reducing their practicality in vehicles or equipment that use internal combustion engines. For example, some systems require multiple fluid tanks to contain sources of distilled water and electrolytes for supplying a main reservoir tank where the electrolysis occurs. However, most vehicles or equipment with internal combustion engines do not have excess room for multiple fluid tanks. Furthermore, these tanks and their contents create additional weight which reduces the fuel efficiency of the vehicle or equipment containing the internal combustion engine.

Accordingly, any improvement for an electrolysis system for an internal combustion engine system that provides oxygen and hydrogen gas as a fuel supplement to the petroleum fuel source could lead to significant benefits. Improvements to such systems could lead to more internal combustion engines being outfitted with such a system. This would provide the beneficial effect of not only increasing fuel efficiency for the engines in those vehicles or equipment, but also would create beneficial effects for the environment by reducing consumption of gasoline and diesel fuels and reducing emissions of toxins into the atmosphere.

Thus, there is a need for an improved electrolysis system for an internal combustion engine that will improve fuel combustibility and reduce harmful emissions without the disadvantages as described above.

### SUMMARY OF THE INVENTION

The present invention provides for an electrolysis system for supplementing an internal combustion engine's petroleum fuel supply with oxygen and hydrogen. One advantage of the electrolysis system is that it includes a filter system that filters and collects entrapped electrolyte particles in the gas.

Furthermore, by collecting the electrolyte particles after the electrolysis reaction, the electrolytes may be returned to the main reservoir tank such that a separate storage tank for the electrolyte solution stored on the vehicle or equipment is not necessary. This helps contribute to a more sleek design for the electrolysis system, making it more feasible to be used in a variety of applications.

Advantageously, the capturing of the electrolyte particles in the filter system results in less overall consumption of the electrolyte during use of the electrolysis system. This practice will result in savings of using the electrolysis system by using less raw materials.

In one aspect, the present invention provides for an electrolysis system that includes a reservoir tank that has a solution of water and electrolyte and at least two plates that are disposed within the reservoir tank such that at least a portion of each plate contacts the solution. The plates are in electrical communication with a source of electrical power such that the plates create an electrical current in the solution to produce a gas including oxygen and hydrogen. The electrolysis system also includes a filter system in fluid communication with the reservoir tank. The filter system includes a filter constructed of interconnected particles configured to capture electrolyte particles in the gas by breaking down the gas. A conduit in fluid communication with the filter system and the internal combustion engine is also provided in the electrolysis system for delivering the gas to the internal combustion engine.

In another aspect, the invention provides for a filter system for an electrolysis system used for supplementing an internal combustion engine's petroleum fuel supply with a gas that includes oxygen and hydrogen. The filter system includes a filter that has interconnected particles configured to capture electrolyte particles in the gas by breaking down the gas. The filter system is in fluid communication with the electrolysis system and the internal combustion engine.

In a further aspect, the present invention provides for a method of supplying an internal combustion engine with hydrogen and oxygen to supplement the engine's petroleum fuel supply. The method includes the step of providing an electrolysis system that includes a reservoir tank having a solution of water and electrolyte. The electrolysis system also includes at least two plates being disposed within the reservoir tank such that at least a portion of each plate contacts the solution. The plates are in electrical communication with a source of electrical power. Also provided in the electrolysis system is a filter system that is in fluid communication with the reservoir tank and includes a filter comprised of interconnected particles configured to capture electrolyte particles in the gas by breaking down the gas. The electrolysis system has a conduit in fluid communication with the filter system and the internal combustion engine for delivering the gas to the internal combustion engine. Another step of the method is running an electrical current through the plates and the solution to produce a gas including hydrogen and oxygen. Other steps of the method include filtering the gas by configuring the filter system such that the gas flows through the filter of interconnected particles, and supplying the gas to the internal combustion engine.

These and still other advantages of the invention will be apparent from the detailed description and drawings. What follows is merely a description of preferred embodiments of the present invention. To assess the full scope of the invention, the claims should be referenced because the preferred embodiments are not intended to be the only embodiments within the scope of the claims.

### BRIEF DESCRIPTION OF THE DRAWINGS

FIG. 1 is a front elevational view of an electrolysis system embodying the invention, wherein the electrolysis system is disposed within a housing, the housing being shown in a section format;

FIG. 2 is a perspective view of the reservoir tank and support structure therefor for the electrolysis system shown in FIG. 1;

FIG. 3 is an exploded view of FIG. 2, showing only one support rod and related fasteners and with the fittings for the gas outlet port and return condensate port removed;

FIG. 4 is a sectional view along line 4-4 from FIG. 2 with the support rods and associated non-conductive sheaths shown in full;

FIG. 5 is a front elevational view of a battery connection plate that forms part of the electrolysis system from FIG. 1;

FIG. 6 is a front elevational view of a floater plate that forms part of the electrolysis system from FIG. 1;

FIG. 7 is a front elevational view of an end plate that forms part of the reservoir tank of the electrolysis system from FIG. 1; and

FIG. 8 is a detailed section view of the filter system from the electrolysis system shown in FIG. 1.

### DETAILED DESCRIPTION OF THE PREFERRED EMBODIMENT

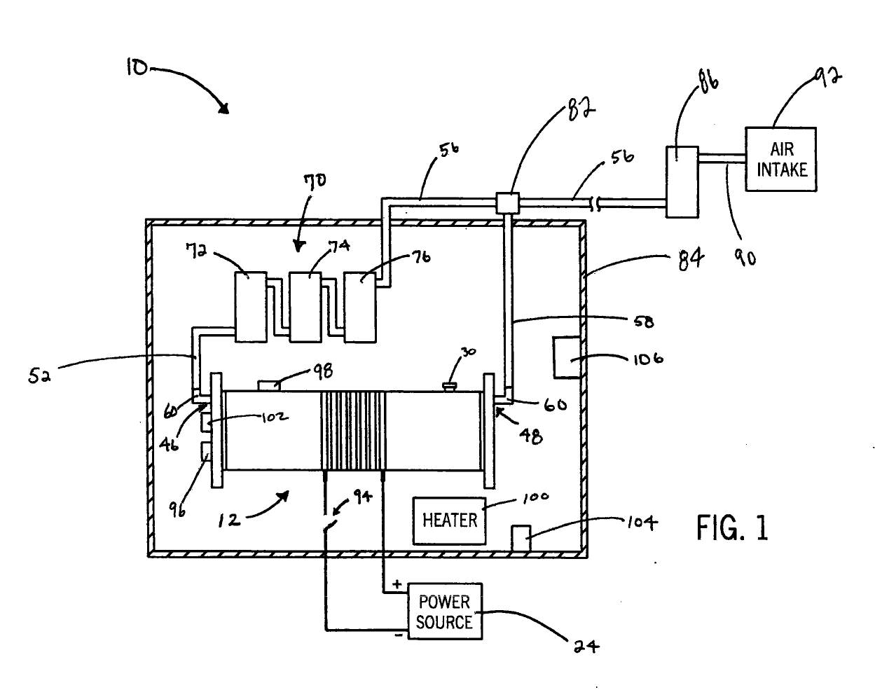

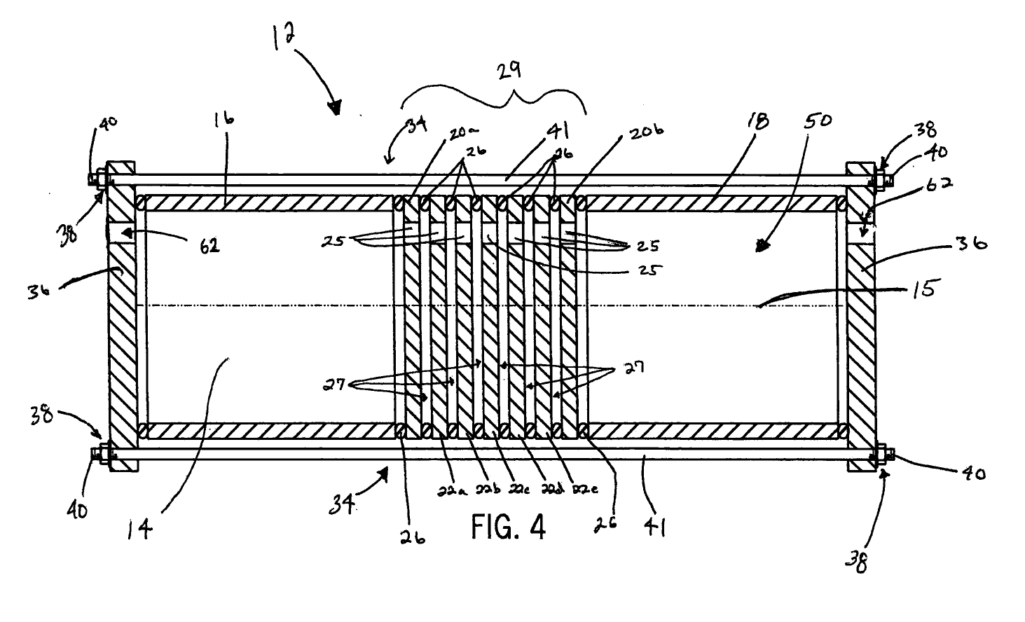

FIG. 1 shows an electrolysis system 10 for producing oxygen and hydrogen to supplement the petroleum fuel supply of an internal combustion engine (not shown). The electrolysis system 10 includes a reservoir tank 12 that houses a solution 14 of water and electrolyte as seen in FIG. 4.

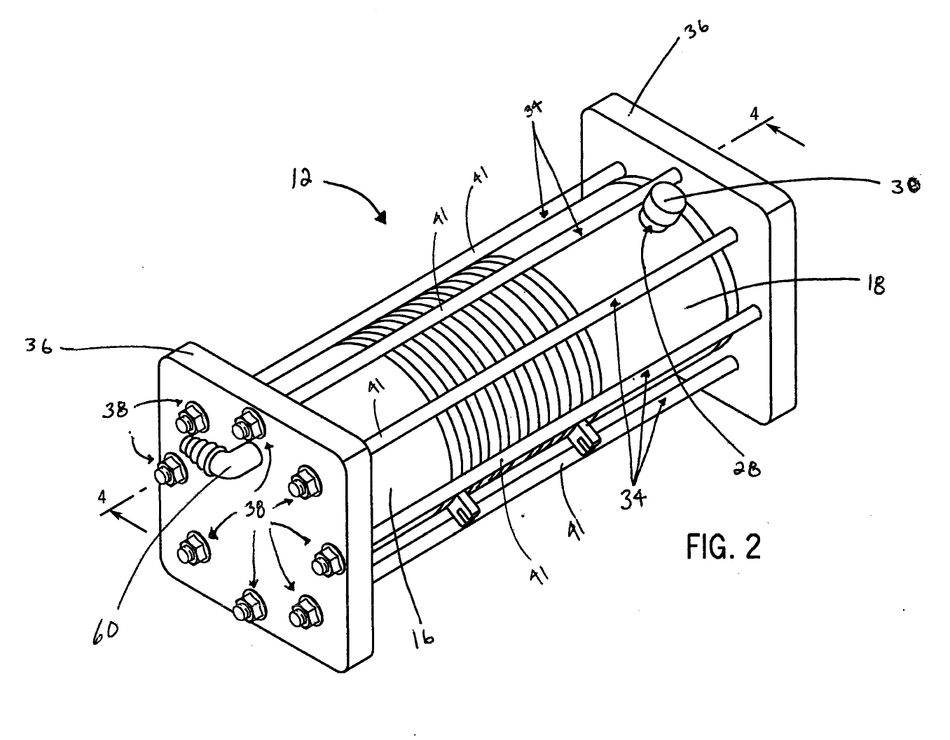

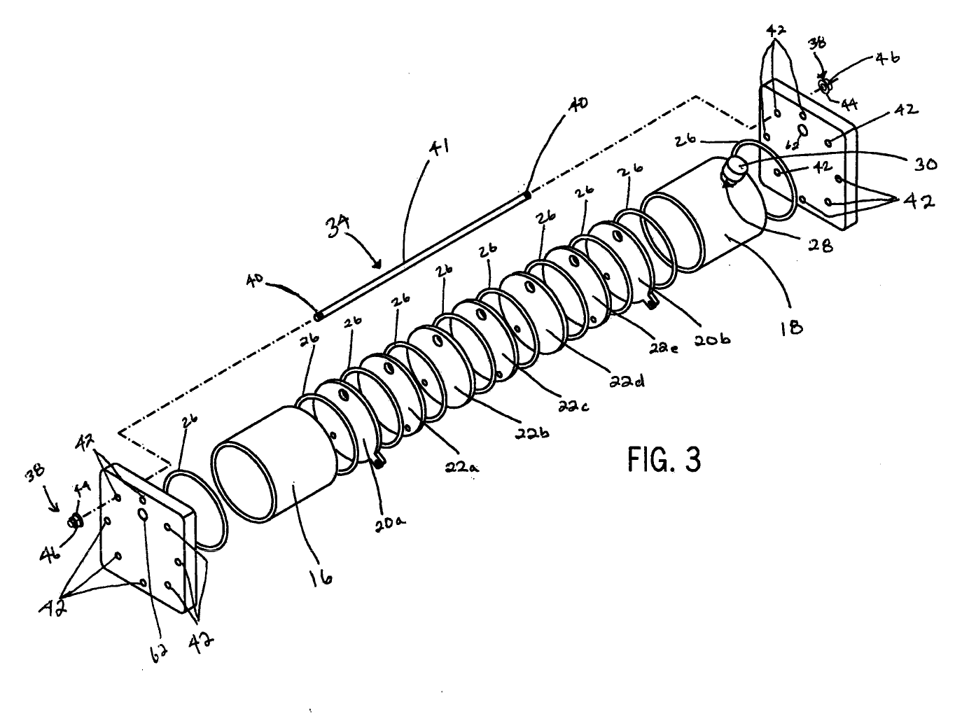

FIGS. 2 and 3 portray the components that form the reservoir tank 12 and supporting structure therefor. The reservoir tank 12 is of a cylinder-shaped construction, but it can be appreciated that the tank 12 may be constructed in other forms. The reservoir tank 12 is constructed of two tube sections 16, 18. Located between the two tube sections 16, 18 of the reservoir tank 12 are a series of plates 20a, 20b, 22a-22e.

The plates may be described as two different types of plates: battery connection plates 20a, 20b, and floater plates 22a-22e. Battery connection plates 20a, 20b are plates that are directly connected to the power source 24 (best seen in FIG. 1) and floater plates 22a-22e are plates located between the battery connection plates 20a, 20b (best seen in FIG. 3). The configuration and amount of plates shown in FIGS. 1-4 is referred to as a single cell 29 construction for an electrolysis system 10. As will be described later, the electrolysis system 10 may be configured to include two or more cells 29.

The power source 24 in the electrolysis system 10 may originate from a battery, or an alternator. If a battery is used as the power source 24, a high output alternator may be used to charge the battery. As will be described below, the voltage of the power source 24 may vary the amount of floater plates 22a-22e that are used in the electrolysis system 10. A common battery that is used in vehicles with an internal combustion engine is a 12 VDC battery, and thus, the set-up of the electrolysis system 10 displayed in FIGS. 1-4 is created based on the use of a 12 VDC battery as the power source 24.

Referring to FIGS. 3, 5, and 6, the construction of the battery connection plates 20a, 20b and floater plates 22a-22e is shown. The battery connection plates 20a, 20b include a connector tab 21 for connecting to a power source 24, as well as a solution-leveling hole 23 and a gas hole 25. All the floater plates 22a-22e also include a gas hole 25, and are of approximately the same outer diameter as the battery connection plates 20a, 20b. The solution-leveling hole 23 in each plate allows the solution 14 to disperse throughout the reservoir tank 12. The gas hole 25 allows gas 50 that is produced by electrolysis to be passed downstream in the electrolysis system 10, as will be described below.

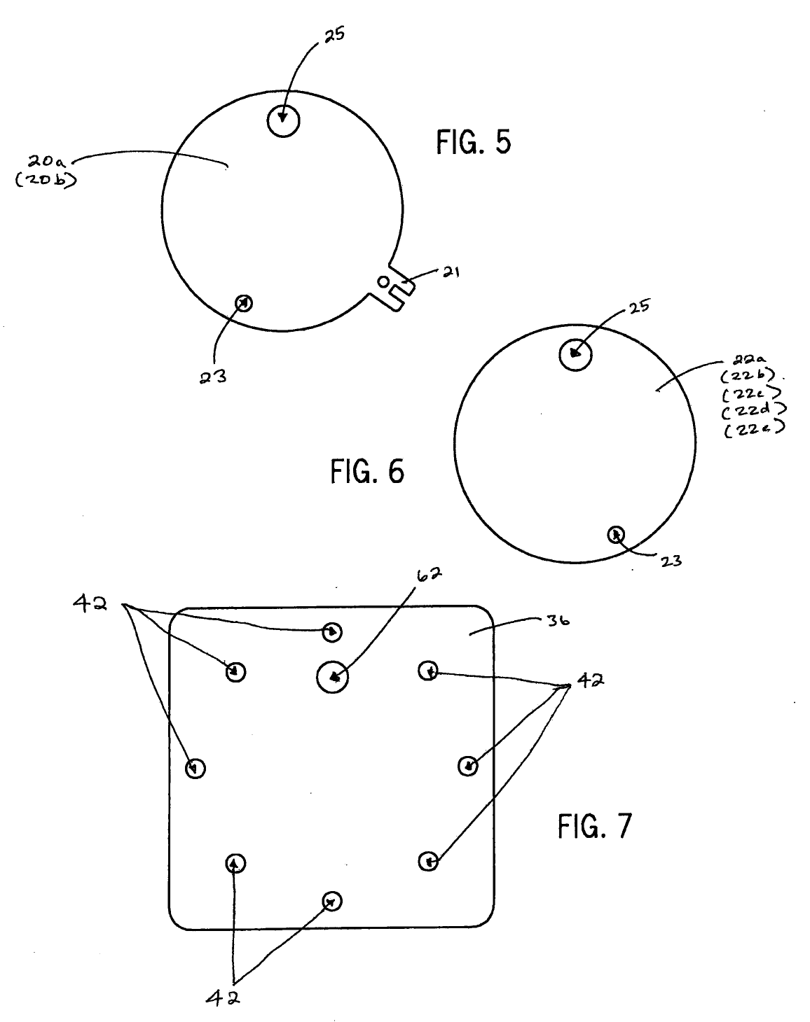

The battery connection plates 20a, 20b may be constructed identically, a sample of which is shown in FIG. 5. Similarly, the floater plates 22a-22e may be constructed identically as well, as seen in FIG. 6. All the plates 20a, 20b, 22a-22e are constructed of a conductive material including, but not limited to, stainless steel, nickel, and nickel alloys. However, the plates 20a, 20b, 22a-22e are preferably made from Grade 316 Stainless Steel. The specific orientation and function of the plates 20a, 20b, 22a-22e within the electrolysis system 10 will be described in further detail below.

Before the plates 20a, 20b, 22a-22e are placed into the electrolysis system 10, they should be cleaned to remove any foreign matter or oils that may reduce their conductivity or interaction with the solution 14 in the reservoir tank 12. The plates 20a, 20b, 22a-22e may be cleaned in an acidic solution and may be handled with gloves when assembling the electrolysis system 10, so as to not contaminate the surface of the plates 20a, 20b, 22a-22e.

As seen in FIGS. 3 and 4, separating each adjacent plate is a gasket 26. A gasket 26 also separates the battery connection plates 20a, 20b from the two adjacent tube sections 16, 18 of the reservoir tank 12, respectively. The gaskets 26 function to ensure that the distance between each adjacent plate is uniform throughout the electrolysis system 10 as well as form a seal for the reservoir tank 12 such that the tank 12 does not leak the solution 14 between adjacent plates or between the battery connection plates 20a, 20b and the tube sections 16, 18 of the reservoir tank 12. As seen in FIG. 3, the gaskets 26 may be O-rings.

Also forming part of the reservoir tank 12 is a solution port 28 and cap 30. The solution port 28 is shown as being located on tube section 18, but could be located on section 16. The solution port 28 may be used to fill as well as refill the solution 14 of water and electrolyte that is placed within the reservoir tank 12 as necessary.

To maintain the reservoir tank 12 in its assembled state as seen in FIG. 2 and seal the reservoir tank 12 on its ends, a series of support rods 34 are used in conjunction with end plates 36 and fasteners 38 to apply a compressive force to the reservoir tank 12. The end plates 36 are preferably constructed of polymethyl methacrylate (PMMA), commonly referred to as “plexiglass.” As PMMA is clear, the end plates 36 may allow a user to visually inspect the amount of solution 14 that remains in the reservoir tank 12. However, it can be appreciated that the end plates 36 may be constructed of other polymers or metals.

The support rods 34 may be threaded along their entire length or have threaded end sections 40. The end sections 40 pass through clearance holes 42 in the end plates 36 and threadably engage fasteners 38 to compress each end plate 36 against the tube sections 16, 18 of the reservoir tank 12. The fasteners 38 used may include a washer 44 that is placed against end plate 36 and tightened with a nut 46. Additionally, a non-conductive sheath 41 may cover the rods 34 to prevent any arcing between the plates 20a, 20b, 22a-22e and the rods 34.

A gas outlet port 46 and return condensate port 48 also form part of the reservoir tank 12. The gas outlet port 46, allows the gas 50 that includes hydrogen and oxygen that is produced through electrolysis to exit the reservoir tank 12 through a conduit 52. The conduit 52 allows the gas 50 to flow to the filter system 70. The return condensate port 48 allows any liquid that leaves the filter system 70 or forms in the conduit 56 downstream of the filter system 54 to return to reservoir tank 12 through conduit 58 connecting to the return condensate port 48. A ninety-degree fitting 60 may be used on both the gas outlet port 46 and the return condensate port 48 to connect to conduit 52, 58, respectively. As the ports 46, 48 are in fluid communication with the reservoir tank 12, the fittings 60 are fitted in holes 62 in the end plates 36 by a threaded fit, press fit, adhesive, or the like. In an alternative configuration, the ports 46, 48 can be located on top of the tube sections 16, 18 of the reservoir tank 12.

As seen in FIG. 1, a filter system 70 also forms part of the electrolysis system 10. The filter system 70 is in fluid communication with the reservoir tank 12 through conduit 52 such that the gas 50 that emits from the solution 14 during electrolysis rises through conduit 52 to the filter system 70. As seen in FIG. 8, the filter system 70 in FIG. 1 includes three individual filter housings 72, 74, and 76 that each contain a filter 72a, 74a, and 76a. The filters 72a, 74a, 76a are submersed in distilled water 78 in their respective housings 72, 74, 76. Connecting each of the filter housings 72, 74, 76 is a filter conduit 80.

As shown in FIGS. 1 and 8, the filter conduit 80 is connected to each housing 72, 74, 76 such that the filters 72a, 74a, 76a are connected in a series relationship. As gas 50 flows from the reservoir tank 12 through conduit 52, the gas 50 first enters the inlet 72b of the first filter housing 72. Then, the gas 50 flows through the first filter 72a, through the distilled water 78 in the first filter housing 72 and out through the outlet 72c of the first filter housing 72. The filter conduit 80 then connects the outlet 72c of the first filter housing 72 to the inlet 74b of the second filter housing 74 such that the gas 50 may travel from the first filter housing 72 to the second filter housing 74. The travel of the gas 50 through the second and third filter housings 74, 76 is the same as for the first filter housing 72 as just described. Thus, the gas 50 is filtered three separate times by the three filters 72a, 74a, and 76a. However, the filter system 70 is not limited to including three separate filter housings 72, 74, 76 and filters 72a, 74a, and 76a, but may be composed of one, two, or four or more filters and associated housings.

The filters 72a, 74a, 76a are composed of interconnected particles. Preferably, the filters 72a, 74a, 76a are composed of glass-bonded silica particles, which are silica particles that are bonded with an alkali metal silicate such as sodium silicate, potassium silicate, mixtures thereof, and the like. The glass bonded silica filters 72a, 74a, 76a may be machined from a solid block of glass bonded silica. Preferably, the pore sizes in the filter 72a, 74a, 76a are machined to be about 30 micrometers in diameter. This type of filter can be referred to as an “air diffuser” or “air stone.”

Once the gas 50 passes through the filter system 70, the gas 50 travels through conduit 56 that is in fluid communication with the outlet 76c of the third filter housing 76 and, ultimately, the internal combustion engine. However, as seen in FIG. 1, the conduit 56 may also include a moisture separator 82 in the flow path to the internal combustion engine. The moisture separator 82 may help to remove any condensation or vapor formed or collected in the conduit 56. As described above, the moisture separator 82 is in fluid communication with the reservoir tank 12 through the return condensate port 48 and conduit 58. Importantly, the moisture separator 82 includes a one-way valve, such that gas 50 from the reservoir tank 12 does not bypass the filter system 70 by rising through conduit 58 and entering conduit 56 that is downstream of the filter system 70. Rather, the moisture separator 82 only allows liquid condensate in conduit 56 to flow to conduit 58 and return to the reservoir tank 12.

After exiting the filter system 70, the gas 50 then travels through conduit 56 to the dry sump 86. The dry sump 86 may be a housing containing a solution of water to bubble the gas 50 through before the gas 50 is delivered to the internal combustion engine. The water in the dry sump 86 acts as a flashback suppressant to prevent any possible ignition of gas 50 upstream of the dry sump 86.

As seen in FIG. 1, after the gas 50 is bubbled through the dry sump 86, the gas 50 exits the dry sump 86 through a conduit 90 that is in fluid communication with the internal combustion engine. In the preferred embodiment, the conduit 90 terminates in the air intake housing 92. The air intake housing 92 often includes an air filter (not shown), which may filter any vapor from the gas 50 before the gas 50 is drawn into the cylinders of the internal combustion engine.

As seen in FIG. 1, the electrolysis system 10 as described to this point, including the reservoir tank 12, plates 20a, 20b, 22a-22e, filter system 70, and associated conduits 52, 56, 58, 80 may be disposed within a housing 84. Although not shown in FIG. 1 as being within the housing 84, the moisture separator 82 may also be disposed within the housing 84. The housing 84 may provide support for mounting the electrolysis system 10 and its individual components, as well as protection for the electrolysis system 10 from the elements and surrounding environment. In fact, the housing 84 may provide a way of retaining heat in the electrolysis system 10 when the electrolysis system 10 is used in colder environments. The housing 84 may also contain vented sides, such that some heat may be released to prevent the electrolysis system 10 from reaching too high of a temperature, especially if the electrolysis system 10 will be used on a vehicle or equipment in warmer environments.

However, the electrolysis system 10 need not be disposed within a housing 84 as depicted in FIG. 1. Instead, the electrolysis system 10 and its individual components and systems may be mounted on structure associated with the vehicle or equipment in which the electrolysis system will be used.

Having discussed the structure of a preferred embodiment of the electrolysis system 10, the function of such a system 10 will now be described. A user first must fill the reservoir tank 12 with a solution 14 of water and electrolyte. Preferably, the electrolyte used in the electrolysis system 10 is potassium hydroxide (KOH). However, other electrolytes may be used and include, but are not limited to, sodium hydroxide, sodium bicarbonate, potassium bicarbonate, vinegar, and combinations thereof. In the preferred embodiment, only two to four ounces of electrolyte are used per gallon of solution 14. Thus, the preferred ratio of electrolyte/water for the solution 14 is about 1.5% to about 3.5%. In comparison, other electrolysis systems use a much higher ratio of electrolyte/water, often employing a solution 14 with a ratio that is above 25%. Advantageously, the smaller percentage of electrolyte used in the solution 14 reduces operating costs of the electrolysis system 10 by reducing raw materials, as well as prolongs the life of the filter system 70.

The solution 14 is filled in the reservoir tank 12 by first removing cap 30 from the solution port 28 and pouring a solution 14 of electrolyte and water into the reservoir tank 12. As described above, the solution-leveling holes 23 in each plate 20a, 20b, 22a-22e allow the solution 14 to disperse throughout the tank 12. As seen by solution line 15 in FIG. 4, the solution 14 should not completely fill the reservoir tank 12, but may be filled to a level below the gas exit holes 25 in the plates 20a, 20b, 22a-22e, as there must be some volume in the tank 12 to allow gas 50 that is created during electrolysis to temporarily accumulate and transfer to the conduit 52 such that it may travel to the filter system 70, and ultimately be consumed.

The orientation of the plates 20a, 20b, 22a-d are depicted in FIG. 3. Battery connection plates 20a and 20b are in direct electrical communication with the negative and positive terminals of a power source 24, respectively, and are the outermost plates in the electrolysis system 10. As described above, FIG. 5 displays the orientation and construction of the battery connection plates 20a, 20b. Floater plates 22a-e, the construction of which is shown in FIG. 6, are placed between the battery connection plates 20a, 20b, with a gasket 26 placed between each adjacent plate, as previously described. As seen in FIG. 3, the plates 20a, 20b, 22a-22e are oriented in the electrolysis system 10 such that the gas hole 25 of each adjacent plate is aligned, in approximately the twelve o'clock position on the plates 20a, 20b, 22a-22e. However, the solution-leveling holes 23 do not align along the axis of the electrolysis system 10. Rather, the plates 20a, 20b, 22a-22e are oriented such that each adjacent plate alternates the side on which the solution-leveling hole 23 is located.

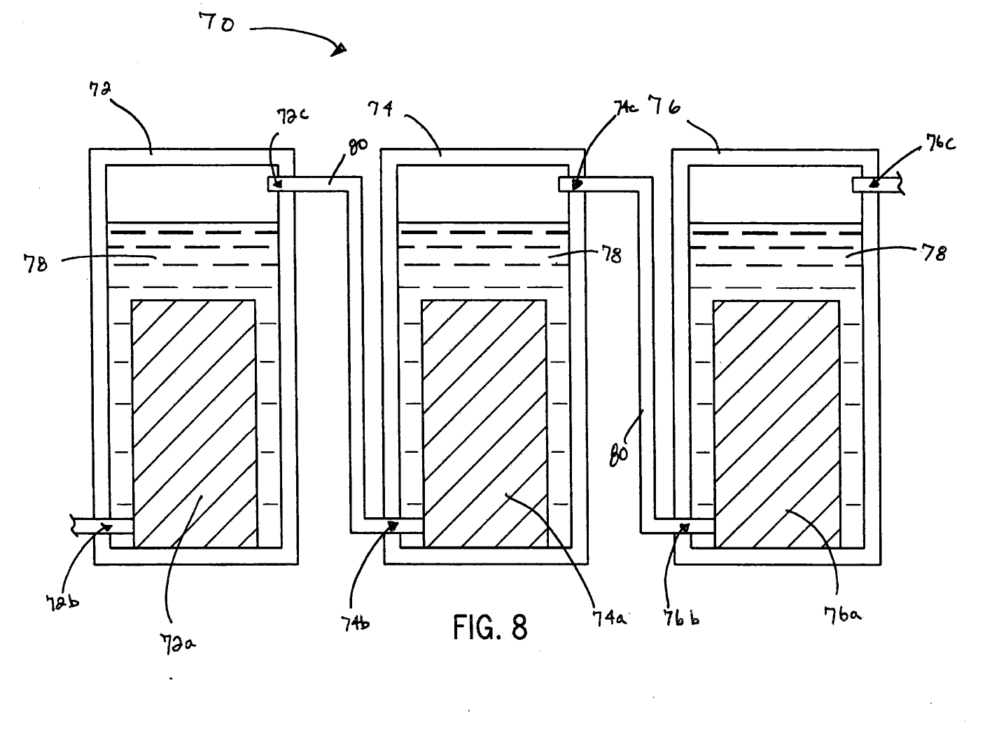

After filling the reservoir tank 14 with an adequate amount of solution 14, the electrolysis reaction may occur once power is provided to the electrolysis system 10. As referenced above, plates 20a, 20b are connected to a power source 24. In the embodiment shown in FIGS. 1-8, plate 20a is in electrical communication with the negative terminal of the battery and forms the cathode, with plate 20b being in electrical communication with the positive terminal of the battery and forms the anode. The exact orientation of the connection of plates 20a, 20b to the positive and negative terminals of the power source 24 may be switched from the orientation as just described.

Once power is provided to the electrolysis system 10, plates 20a, 20b, 22a-22e and the solution 14 form part of an electric circuit. Thus, an electrical current is passed from plate 20a to plate 20b by passing through the solution 14. The preferred amount of floater plates 22a-22e used in the electrolysis system 10 may vary. The number of gaps 27, or areas of solution 14 between adjacent plates 20a, 20b, 22a-22e (best seen in FIG. 4), should be optimized such that a voltage drop of 1.5 V to 2.5 V occurs across each gap 27. Thus, for the embodiment shown in FIGS. 1-8, there is a total of seven plates 20a, 20b, 22a-22e which create a total of six gaps 27. If hooked up to a 12 VDC battery as the power source 24, each gap 27 would approximately experience a 2 V drop because the gaps 27 all have approximately the same resistance to the electrical current and the gaps 27 are set up in a series relationship. Thus, the voltage drop across each gap 27 is equal to the total voltage (12 V) divided by the amount of gaps 27. If a 24V battery were used as a power source 24 in a single cell 29 the electrolysis system 10, the total number of floater plates may be increased from five to eleven, such that the there would be twelve gaps 27 and the voltage drop across each gap 27 may be approximately two volts.

Another important aspect of the configuration of the plates 20a, 20b, 22a-22e of the electrolysis system 10 is the staggered alignment of the solution-leveling holes 23. As previously discussed, the floater plates 22a-22e are set up such that the solution-leveling holes 23 in adjacent plates are misaligned. The plates 20a, 20b, 22a-22e are set up in this manner such that the appropriate voltage drop of about 1.5 V to about 2.5 V is realized across each gap 27. If the solution-leveling holes 23 in all the plates 20a, 20b, 22a-22e were aligned, the electric current may pass through each solution-leveling hole 23 of the floater plates 22a-22e in its path between the battery connection plates 20a, 20b. This would result in a larger voltage drop, as the solution 14 would be the only resistance in the electrical circuit. Instead, by staggering the solution-leveling holes 23 between adjacent plates 20a, 20b, 22a-22e, the electrical current is more likely to flow from battery connection plate 20a to battery connection plate 20b by passing through the solution 14 and each successive floater plate 22a-22e because the distance between adjacent plates is shorter (and thus of less resistance) as compared to the distance through the solution 14 between the misaligned solution-leveling holes 23. Accordingly, this staggered alignment of solution-leveling holes 23 results in the appropriate voltage drop to occur in the gaps 27 of the cell 29.

The electrolysis system 10 may be modified to include more than one cell 29. In such an embodiment, the principle of maintaining the desired voltage drop across each gap 27 to be about 1.5 V to about 2.5 V may still be followed by employing an appropriate amount of floater plates between the battery connection plates. For example, a two cell 29 construction may be configured with three battery connection plates and ten floater plates. Two battery connection plates would be placed on the ends to form the outermost end of each cell 29 and a battery connection plate would be placed in the center to form the other end of each cell 29. Five floater plates would be placed in between the battery connection plates for each cell 29. The battery connection plates would be connected to the power source 24 in a fashion such that each successive battery connection plate in the electrolysis system 10 is connected to a different terminal of the power source 24. By increasing the number of cells 29 in the electrolysis system 10, but still keeping the voltage drop to the desired amount across each gap 27, more hydrogen and oxygen may be produced in gas 50 to deliver to the internal combustion engine.

Although the battery connection plates 20a, 20b are electrically connected to the terminals of the power source 24, the electrolysis system 10 may be limited to producing gas 50 only when desired. This may be accomplished by using a relay 94 that only allows current to flow from the power source 24 to the battery connection plates 20a, 20b when a certain condition is met. For example, the relay 94 may be configured to activate only when sensing a certain amount of engine oil pressure. In this configuration, the electrolysis system 10 would be prevented from running when the vehicle or equipment with the internal combustion engine is not being used, and thus, would prevent the electrolysis system 10 from draining the power source 24.

As long as relay 94 is engaged, the electrolysis system 10 produces a gas 50 that includes oxygen and hydrogen through electrolysis. As previously described, the hydrogen and oxygen gases are formed by splitting water molecules into positively charged hydrogen ions and negatively charged hydroxide ions. The hydrogen ions form hydrogen gas molecules, H₂, by collecting at the cathodes and the hydroxide ions form oxygen gas molecules, O₂, by collecting at the anodes. The gas 50 produced may collect and stick on the plates 20a, 20b, 22a-22e before rising to the top of the reservoir tank 12. To reduce the duration of time that bubbles of the gas 50 stick on the plates 20a, 20b, 22a-22e, the inward-facing sides of the battery connection plates 20a, 20b and both sides of the floater plates 22a-22e may be etched or roughened, for example, in a cross-hatching pattern. This etching will also increase the surface area of the plates 20a, 20b, 22a-22e and may improve the electrolysis reaction in the reservoir tank 12.

As the gas 50 is produced in the tank 12, the gas 50 collects near the top of the reservoir tank 12. Each plate 20a, 20b, 22a-22e includes a gas hole 25 such that the gas 50 may pass to the end of the tank 12 where the gas outlet port 46 is located. Due to the small difference in pressure between the reservoir tank 12 and the filter system 70, the gas 50 may flow through the gas outlet port 46 and through conduit 52 to the filter system 70 naturally. The filter system 70 may also be located above the reservoir tank 12, such that the gas 50 naturally rises to the filter system 70 due to the low density of the gas 50.

The filter system 70 performs multiple functions. First, the filter system 70 filters the gas 50 that is produced in the tank 12 before the gas 50 is delivered to the internal combustion engine. As described above, the filter system may include three separate filters 72a, 74a, 76a that include glass-bonded silica air diffusers placed in three separate filter housings 72, 74, 76. The filters 72a, 74a, 76a may each be connected in a series relationship such that the gas 50 is filtered three separate times. The filtering of the gas 50 occurs by breaking down the particle size of the gas 50 by forcing the gas 50 through the pores of the filter 72a, 74a, 76a, which may be approximately 30 micrometers in diameter. After the gas 50 flows through the filters 72a, 74a, 76a, the gas 50 is bubbled through the distilled water 78 that is in each filter housing 72, 74, 76. By breaking down the gas 50, any electrolyte particles trapped in the gas 50 are more likely to be removed from the gas 50 and collected by the distilled water 78 because the electrolyte is water soluble. If not removed from the gas 50, the electrolyte particles may decrease performance or otherwise negatively affect components of the internal combustion engine, or other components of the vehicle or equipment in which the engine is used.

Importantly, although the filtering of the gas 50 may be sufficient after one pass through a filter 72a, the preferred embodiment includes three filters 72a, 74a, 76a to provide further assurance that the electrolyte particles are removed from the gas 50 before the gas 50 is delivered to the engine.

As such, the filter system 70 also acts as a collection mechanism for the electrolyte particles that travel out of the reservoir tank 12 with the gas 50. After the electrolysis system 10 has been used for some time and the level of solution 14 in the reservoir tank 12 becomes low, the user may refill the tank 12 by first emptying the distilled water 78 from the filter housings 72, 74, 76 into the tank 12. This may be done by manually removing the filter housings 72, 74, 76 from the conduit 80 and dumping the distilled water 78 into the reservoir tank 12, or by connecting a conduit and valve system to the bottom of each filter housing 72, 74, 76 to be in fluid communication with the reservoir tank 12. Then, the user may open the valves on the filter system 70 to allow the distilled water 78 to flow into the reservoir tank 12. In either case, the user may then refill the filter housings 72, 74, 76 with distilled water 78 and fill the reservoir tank 12 to a sufficient level, as previously described. A pump system (not shown) can also be used to transfer the distilled water 78 from the filter housings 72, 74, 76 to the reservoir tank 12 and/or to refill the filter housings 72, 74, 76 with distilled water 78. By placing the collected electrolyte that was filtered out of the gas 50 back into the reservoir tank 12, the electrolyte is effectively being recycled, which results in a lower cost for operating the electrolysis system 10.

The filter system 70 also acts as a flashback suppressant. Because the three filter housings 72, 74, 76 each contain distilled water 78, the filter system 78 prevents any ignition of the gas 50 that may occur downstream of filter system 70 from spreading to the reservoir tank 12 where the gas 50 is produced.

After the gas 50 exits the filter system 70, it passes through conduit 56. As described above, a moisture separator 82 may collect and return any liquid in the conduit 56 to the reservoir tank via conduit line 58. The gas 50 continues in conduit 56 to the dry sump 86. As discussed above, the electrolysis system 10 may be used for internal combustion engines using gasoline or diesel fuel as a primary fuel source. In gasoline engines, which use a spark ignition in the cylinders, a dry sump 86 provides not only one last filter for the gas 50, but also provides an additional flashback suppressant that is downstream of the flashback suppressant qualities of the filter system 70. Even if the electrolysis system 10 is used in an engine that uses diesel fuel as the primary fuel source, which does not employ a spark ignition but ignites due to pressure, the dry sump 86 may still act as a downstream flashback suppressant as an added precaution for stopping any of the gas 50 from igniting upstream of the dry sump 86.

After exiting the dry sump 86 in conduit 90, the gas 50 is delivered to the internal combustion engine. In the embodiment shown in FIGS. 1-8, conduit 90 provides the gas 50 to the air intake housing 92. The gas 50 is delivered to the internal combustion engine as air is drawn into the cylinders of the engine. Even if only idling, the internal combustion engine maintains the throttle valve in a slightly cracked position, such that a small supply of air is drawn into the cylinders of the engine. In such a case, a small amount of gas 50 that includes hydrogen and oxygen will be delivered to the cylinders of the engine. However, as the user opens the throttle valve of the engine, more air will be drawn into the cylinders of the engine, and as such, more hydrogen and oxygen from the gas 50 will be delivered to the engine. The hydrogen and oxygen increase the combustion of the primary fuel source, and therefore, deliver increased horsepower and improved fuel economy to the internal combustion engine. Additionally, less toxins are emitted from the engine to the surrounding environment due to the more complete combustion of the primary fuel source.

The electrolysis system 10 may also contain several sensing features. One such feature is a low water cutoff 96. The low water cutoff 96 may be located on the reservoir tank 12 by mounting to the end plate 36, as seen in FIG. 1. The low water cutoff 96 ensures that the electrolysis system 10 does not continue to run if the solution 14 is lowered past a desired minimum amount in the tank 12. Accordingly, if the low water cutoff sensor 96 is activated, power from the power source 24 will not be supplied to the electrolysis system 10. The low water cutoff sensor 96 may also notify the user that the electrolysis system 10 has been deactivated, and as such, notify the user to refill the solution 14 in the tank 12. Additionally, the low water cutoff sensor 96 may also provide the user with a warning that the level of the solution is approaching a low level in the tank, but has not yet reached the point where the electrolysis system 10 will be deactivated.

Another sensing feature that may form part of the electrolysis system 10 is a high pressure cutoff 98. The high pressure cutoff 98 may be mounted to the reservoir tank 12, as shown in FIG. 1, to measure the pressure inside the reservoir tank 12. Just as described with the low water cutoff 96, the high pressure cutoff 98 may be used to deactivate the electrolysis system 10 in the event that the pressure in the tank reaches a certain specified pressure. High pressure may form in the tank 12 for different reasons, including the situation where a filter 72a, 74a, 76a becomes plugged. Just as described with respect to the low water cutoff 96, the high pressure cutoff 98 may also notify the user when the system 10 is deactivated and also as a warning that the pressure is approaching a level where the system 10 will be deactivated.

The electrolysis system 10 may also be configured to include a heater 100 that is controlled by a thermostat 102. The heater 100 may be located in the housing 84, as seen in FIG. 1, or alternatively, may be mounted on some adjacent structure of the vehicle or equipment in which the engine is used. The heater 100 may be programmed to activate and provide heat for the reservoir tank 12, filter system 70, dry sump 86, and conduits 52, 56, 58, 80, 90 to prevent the solution 14 or other liquid from freezing in those components. The thermostat 102 and heater 100 may be programmed such that when the thermostat 102 senses the electrolysis system 10 has reached a certain temperature, the heater 100 activates until the electrolysis system 10 reaches a certain specified higher temperature. Additionally, the thermostat 102 may also be used as a high temperature sensor to deactivate the electrolysis system 10 in the event that the thermostat 102 senses the temperature is above a specified temperature.

The heater 100 and thermostat 102 may be configured such that the heater may only be activated when the car is running, as a means to prevent the heater 100 from draining the power source 24. On the other hand, the heater 100 and thermostat 102 may be set up to also activate when the AC outlet for an engine heating block is activated, if the vehicle or equipment in which the electrolysis system 10 is being used contains such a feature.

Furthermore, a water sensor 104 may be incorporated as part of the electrolysis system 10. The water sensor 104 may be configured to detect a leak on the reservoir tank 12 by being placed below the tank 12 and in a position where solution 14 that leaks from the tank 12 may collect. For example, the water sensor 104 may be located on the bottom of the housing 84 below the reservoir tank 12.

A fire suppression system 106 may also form part of the electrolysis system 10. The fire suppression system 106 may be located within the housing 84, or on adjacent structure on the vehicle or equipment in which the electrolysis system 10 is being used. The fire suppression system 106 may be activated by either the presence of smoke or by heat.

The foregoing description was primarily directed to a preferred embodiment of the invention. Although some attention was given to various alternatives within the scope of the invention, it is anticipated that one skilled in the art will likely realize additional alternatives within the spirit and scope of the invention that are now apparent from disclosure of embodiments of the invention. Accordingly, the scope of the invention should not be limited to the described embodiments. Rather, the following claims should be referenced to ascertain the full scope of the invention.

What is claimed is:

1. An electrolysis system for supplementing an internal combustion engine's petroleum fuel supply with oxygen and hydrogen, the electrolysis system comprising:
a reservoir tank including a solution of water and electrolyte;
at least two plates being disposed within the reservoir tank such that at least a portion of each plate contacts the solution, the plates being in electrical communication with a source of electrical power configured such that the plates create an electrical current in the solution to produce a gas including oxygen and hydrogen;
a filter system in fluid communication with the reservoir tank, the filter system including a filter comprised of interconnected particles configured to break down the gas; and
a conduit in fluid communication with the filter system and the internal combustion engine for delivering the gas to the internal combustion engine.

2. The electrolysis system of claim 1, wherein at least a portion of the plates are etched.

3. The electrolysis system of claim 1, wherein the electrolyte is potassium hydroxide.

4. The electrolysis system of claim 1, wherein the filter system includes at least one additional filter, and the filters are configured in a series.

5. The electrolysis system of claim 1, wherein the interconnected particles are silica particles.

6. The electrolysis system of claim 1, wherein the filter is a glass-bonded silica air diffuser.

7. The electrolysis system of claim 1, the electrolysis system further comprising a moisture separator located in the flow path of the conduit between the filter system and the internal combustion engine, the moisture separator being in fluid communication with the reservoir tank.

8. The electrolysis system of claim 1, the electrolysis system further comprising a high pressure cut-off switch.

9. The electrolysis system of claim 1, the electrolysis system further comprising a low water cut-off switch.

10. The electrolysis system of claim 1, the electrolysis system further comprising a thermostat controlled heater.

11. The electrolysis system of claim 1, the electrolysis system further comprising a dry sump configured to function as a flashback suppressor.

12. The electrolysis system of claim 1, wherein the electrical power source is a battery.

13. The electrolysis system of claim 1, wherein the reservoir tank is disposed within a housing.

14. The electrolysis system of claim 13, the electrolysis system further comprising a water sensor disposed in the housing and configured to disable the electrolysis system if any solution is detected leaking from the reservoir tank.

15. The electrolysis system of claim 13, the electrolysis system further comprising a fire suppression system disposed in the housing.

16. A filter system for an electrolysis system used for supplementing an internal combustion engine's petroleum fuel supply with a gas that includes oxygen and hydrogen, the filter system comprising:
a filter that includes interconnected particles configured to break down the gas;
wherein the filter system is in fluid communication with the electrolysis system and the internal combustion engine.

17. The filter system of claim 16, wherein the filter system includes at least one additional filter, and the filters are configured in a series.

18. The electrolysis system of claim 16, wherein the interconnected particles are silica particles.

19. The electrolysis system of claim 16, wherein the filter is a glass-bonded silica air diffuser.

20. A method of supplying an internal combustion engine with hydrogen and oxygen to supplement the engine's petroleum fuel supply, the method comprising the steps of:
providing an electrolysis system that includes a reservoir tank having a solution of water and electrolyte, at least two plates being disposed within the reservoir tank such that at least a portion of each plate contacts the solution, the plates being in electrical communication with a source of electrical power, a filter system in fluid communication with the reservoir tank, the filter system including a filter comprised of interconnected particles configured to break down the gas, and a conduit in fluid communication with the filter system and the internal combustion engine for delivering the gas to the internal combustion engine;
running an electrical current through the plates and the solution to produce a gas including hydrogen and oxygen;
filtering the gas by configuring the filter system such that the gas flows through the filter of interconnected particles; and
supplying the gas to the internal combustion engine.

21. The method of claim 20, wherein the interconnected particles are silica particles.

22. The method of claim 20, wherein the filter is a glass-bonded silica air diffuser.

23. The method of claim 20, wherein the filter system includes at least one additional filter, and the filters are configured in a series.
